(19) United States
(12) Patent Application Publication
(10) Pub. No.: US 2022/0129135 A1
(43) Pub. Date: Apr. 28, 2022

(54) TOUCH DEVICE AND DRIVING METHOD THEREOF

(71) Applicant: ZHENZHEN ROYOLE TECHNOLOGIES CO., LTD., Shenzhen, Guangdong (CN)

(72) Inventor: Jianpeng Li, Shenzhen (CN)

(21) Appl. No.: 17/427,654

(22) PCT Filed: Feb. 1, 2019
(86) PCT No.: PCT/CN2019/074390

§ 371 Date: Aug. 1, 2021

(51) Int. Cl. G06F 3/041; G06F 3/044

(52) U.S. Cl. CPC G06F 3/04182; G06F 3/04166; G06F 3/044

(57) ABSTRACT

The present application provides a touch device and a driving method thereof. The touch device comprises a touch panel and a touch drive IC, and the touch panel is provided with multiple driving circuits and multiple sensing circuits. The driving method comprises: inputting two drive signals having an equal amplitude and opposite phases to the driving circuits; obtaining sensing signals by means of the sensing circuits; and removing or attenuating original noise signals comprised in the sensing signals by means of the touch drive IC.

### TECHNICAL FIELD

The present application relates to the technical field of electronic equipment, and in particular, to a touch device and a driving method thereof.

### BACKGROUND OF THE INVENTION

With the development of the touch control technology, more and more electronic devices are equipped with a touch panel. However, the touch panel is susceptible to interference from other electronic components during use, resulting in the problem that the positioning of the touch coordinates is inaccurate.

### BRIEF SUMMARY OF THE INVENTION

The present application provides a touch device and a driving method thereof, to effectively eliminate the noise signal contained in the sensing signal, so as to perform the accurate touch sensing operation and improve the reliability of the touch sensing operation.

In a first aspect, the present application provides a driving method for a touch device, wherein the touch device comprises a touch panel, and a plurality of driving circuits and a plurality of sensing circuits are provided on the touch panel, with the driving method comprising:

inputting respectively two driving signals, which have equal amplitudes and opposite phases, to a same driving circuit in one scanning period;

receiving a sensing signal through the sensing circuits; and

performing a first signal processing on two sensing signals received by each sensing circuit and corresponding to the two driving signals transmitted on the same driving circuit, so as to remove or attenuate an original noise signal contained in the sensing signals received by each sensing circuit.

In a third aspect, the present application provides a touch device, comprising a touch panel and a touch drive IC, the touch panel being provided with plural driving circuits and plural sensing circuits, wherein the touch drive IC is configured for:

inputting respectively two driving signals, which have equal amplitudes and opposite phases, to a same driving circuit in one scanning period;

receiving a sensing signal through the sensing circuits; and

performing a first signal processing on two sensing signals received by each sensing circuit and corresponding to the two driving signals transmitted on the same driving circuit, so as to remove or attenuate a noise signal contained in the sensing signals received by each sensing circuit.

In a third aspect, the present application provides a driving method for a touch device, the touch device comprising a touch panel, the touch panel comprising a plurality of groups of driving circuits arranged in a row direction and a plurality of groups of sensing circuits arranged in a column direction. Each group of the driving circuits comprises a first driving circuit and a second driving circuit, and each group of the sensing circuits comprises a first sensing circuit corresponding to the first driving circuit of the each group of driving circuits and a second sensing circuit corresponding to the second driving circuit of the each group of driving circuits.

The driving method comprises:

inputting simultaneously driving signals, which have equal amplitudes and opposite phases, to the first driving circuit and the second driving circuit comprised in a same group of driving circuits in one scanning period;

receiving a sensing signal through the sensing circuits, and detecting a transmission signal on the driving circuit that transmits the driving signal, wherein the transmission signal is a sum of the driving signal transmitted by the corresponding driving circuit and an original noise signal that the touch panel transmits to the corresponding driving circuit;

performing a signal processing on the detected transmission signal to obtain a single noise signal contained in the transmission signal; and

using the single noise signal to respectively cancel or attenuate the original noise signal contained in the sensing signals received by each sensing circuit.

In a fourth aspect, the present application provides a touch device, comprising a touch panel and a touch drive IC, the touch panel comprising plural groups of driving circuits arranged in a row direction and plural groups of sensing circuits arranged in a column direction, wherein each group of driving circuits comprises a first driving circuit and a second driving circuit, and each group of the sensing circuits comprises a first sensing circuit corresponding to the first driving circuit of each group of driving circuits and a second sensing circuit corresponding to the second driving circuit of each group of driving circuits, the touch drive IC being configured for:

inputting simultaneously driving signals, which have equal amplitudes and opposite phases, to the first driving circuit and the second driving circuit comprised in a same group of driving circuits in one scanning period;

receiving a sensing signal through the sensing circuits, and detecting a transmission signal on the driving circuit that transmits the driving signal, wherein the transmission signal is a sum of the driving signal transmitted by the corresponding driving circuit and an original noise signal that the touch panel transmits to the corresponding driving circuit;

performing a signal processing on the detected transmission signal to obtain a single noise signal contained in the transmission signal; and

using the single noise signal to respectively cancel or attenuate the original noise signal contained in the sensing signals received by each sensing circuit.

In a fifth aspect, the present application provides a driving method of a touch device, comprising:

inputting, to a driving circuit, two driving signals having equal amplitudes and opposite phases;

obtaining a sensing signal through a sensing circuit; and

removing or attenuating, by a touch drive IC, an original noise signal contained in the sensing signal.

The touch device and its driving method provided in the first and second aspects of the present application, based on the structure of the existing touch device, input respectively two driving signals having equal amplitudes and opposite phases to the same driving circuit within one scanning period, and perform a signal processing on the two sensing signals received by each sensing circuit and corresponding to the two driving signals transmitted on the same driving circuit, so as to effectively remove or attenuate the original noise signal contained in the sensing signals received by each sensing circuit, and obtains the single touching signal received by each sensing circuit, so that the touch drive IC 22 can perform accurate touch sensing operation according to the received sensing signals, and then improve the reliability of the touch sensing operation.

The touch device and its driving method provided by the third and fourth aspects of the present application, based on the structure of the improved touch device, input simultaneously driving signals having equal amplitudes and opposite phases to two driving circuits included in the same group of driving circuits in one scanning period. While receiving the sensing signals through the sensing circuits, it detects the transmission signal on the driving circuit that transmits the driving signal, and processes the detected transmission signal to obtain a single noise signal contained in the transmission signal, and then uses the obtained single noise signal to respectively cancel or attenuate the original noise signal contained in the sensing signals received by each sensing circuit, to obtain the touching signals received by each sensing circuit, so that the touch drive IC 22 can perform the accurate touch sensing operation according to the received sensing signals, and then improve the reliability of the touch sensing operation.

### BRIEF DESCRIPTION OF THE DRAWINGS

In order to more clearly explain the technical solutions in the embodiments of the present application or the prior art, the drawings that need to be used in the description of the embodiments or the prior art will briefly introduced below. Obviously, the drawings in the following description are merely some of embodiments of the present application. For those skilled in the art, other drawings can be obtained based on these drawings without creative work.

FIG. 1 is a schematic structural diagram of a touch device provided by embodiments of the present application.

FIG. 2 is a schematic diagram for the touch sensing operation of the touch panel and the touch drive IC according to the embodiments of the present application.

FIG. 3 is a schematic side view of the display panel and the touch panel shown in FIG. 1.

FIG. 4 is a schematic diagram of the transmission path along which the noise signal is transmitted from the display panel shown in FIG. 1 to the touch panel.

FIG. 5 is a schematic diagram showing the direction of the touching signal when the driving signal TS is provided to the touch panel.

FIG. 6 is a schematic diagram showing the direction of the touching signal when the driving signal −TS is provided to the touch panel.

FIG. 7 is a schematic diagram showing the subtraction of two touching signals having opposite phases according to the first embodiment of the present application.

FIG. 8 is a schematic diagram showing subtraction of two sensing signals according to the first embodiment of the present application.

FIG. 9 is a schematic diagram of the circuit structure of the second signal processing module provided by the first embodiment of the present application.

FIG. 10 is a schematic diagram of the configuration structure of the driving circuits and the sensing circuits of the touch panel according to the second embodiment of the present application.

FIG. 11 is a schematic structural diagram of the touch panel and the touch drive IC according to the second embodiment of the present application.

FIG. 12 is a schematic diagram showing another transmission path along which the noise signal is transmitted from the display panel shown in FIG. 1 to the touch panel.

FIG. 13 is another schematic structural diagram of the touch panel and the touch drive IC according to the second embodiment of the present application.

FIG. 14 is a flowchart of a driving method for a touch device provided by the first embodiment of the present application.

FIG. 15 is a flowchart of a driving method for a touch device provided by the second embodiment of the present application.

FIG. 16 is a flowchart of a driving method for a touch device provided by the second embodiment of the present application.

### DETAILED DESCRIPTION OF THE INVENTION

The technical solutions in the embodiments of the present application will be described clearly and completely in conjunction with the accompanying drawings in the embodiments of the present application. Obviously, the described embodiments are merely a part of the embodiments of the present application, rather than all of them. Based on the embodiments of the present application, all other embodiments obtained by those skilled in the art without creative work shall fall within the protection scope of the present application.

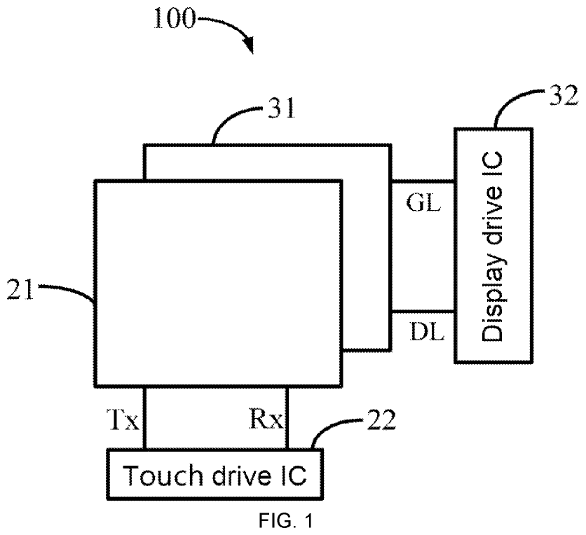

Referring to FIG. 1, it is a schematic structural diagram of a touch device 100 provided by an embodiment of the present application. In this embodiment, the touch device 100 can be applied to electronic products with touch display functions, such as smart phones, tablet computers, e-book readers and so on.

As shown in FIG. 1, the touch device 100 may comprise a touch panel 21, a touch drive integrated circuit (hereinafter, referred to as “touch drive IC”) 22, a display panel 31, and a display drive integrated circuit (hereinafter, referred to as “display drive IC”) 32, wherein the touch panel 21 is disposed on the display panel 31, and the touch panel 21 is used to sense a user's touch and obtain coordinate information of an area where the user's touch is sensed. The panel 31 is used to display text or images.

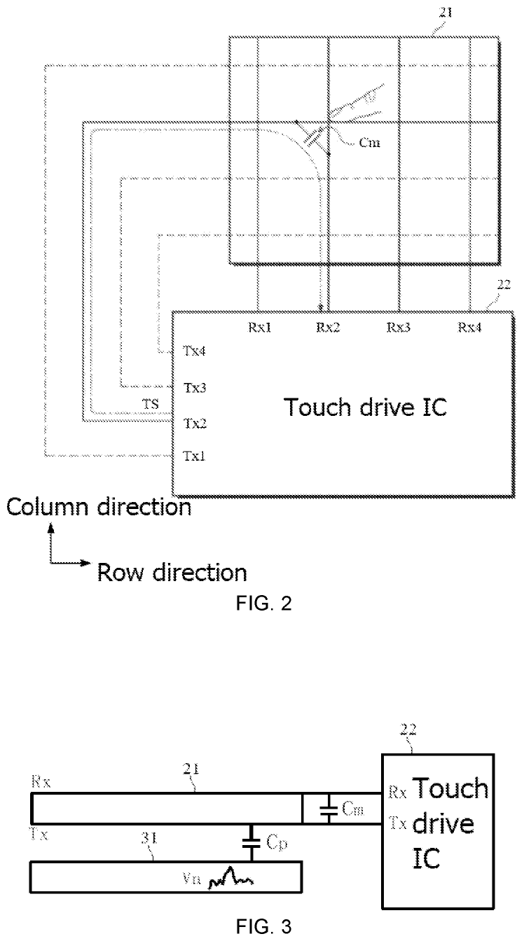

As shown in FIG. 2, the touch panel 21 comprises a plurality of driving circuits Tx (also called “sending circuits/lines”) arranged in the row direction and a plurality of sensing circuits Rx (also called “receiving circuits/lines” or “sensing lines”) arranged in the column direction. The touch panel 21 can receive a driving signal through the driving circuit Tx, and send a touching signal through the sensing circuit Rx.

The touch drive IC 22 is electrically connected to the plurality of driving circuits Tx and the plurality of sensing circuits Rx, respectively, and the touch drive IC 22 sends driving signals to the touch panel 21 through the plurality of driving circuits Tx, receives a touching signal through the sensing circuits Rx, and determines based on the touching signal received by the sensing circuit Rx whether a user touch event occurs on the touch panel 21.

In this embodiment, the touch panel 21 may be a touch panel of various sensing types, such as self-capacitance, mutual capacitance, electromagnetic induction, or resistance. For convenience of description, the embodiments having the concept of the present invention will be described below based on a touch panel of the mutual capacitance type. In addition, in order to better understand the inventive concept of the present application, the touch sensing operation of the touch panel 21 and the touch drive IC 22 will be briefly introduced below in conjunction with FIG. 2.

As shown in FIG. 2, the touch panel 21 comprises four driving circuits Tx1 to Tx4 extending in the row direction and four sensing circuits Rx1 to Rx4 extending in the column direction. It can be understood that in the present application, the touch panel 21 is not limited to the structure shown in FIG. 2 and also comprises more driving circuits and more sensing circuits. In addition, for convenience of description, the driving circuits Tx1 to Tx4 and the sensing circuits Rx1 to Rx4 are shown as straight lines in FIG. 2, but are not limited to this type in practice.

The touch drive IC 22 can input driving signals TS to the driving circuits Tx1 to Tx4, and receive touching signals through the sensing circuits Rx1 to Rx4. For example, as shown in FIG. 2, the touch drive IC 22 can provide a driving signal TS to the touch panel 21 through a second driving circuit Tx2, and the driving signal TS provided to the second driving circuit Tx2 can return to the touch drive IC 22 through the mutual capacitor Cm coupled between the second driving circuit Tx2 and the second sensing circuit Rx2. If the user touches the area where the second driving circuit Tx2 and the second sensing circuit Rx2 intersect, the capacitance of the mutual capacitor Cm located in the touched area changes due to the user's touch. The touching signal received through the second sensing circuit Rx2 changes following the change of the capacitance of the mutual capacitor Cm. Therefore, the touch drive IC 22 can sense the change of the touching signal, that is, sense the user's touch.

For convenience of description, the driving circuits Tx1 to Tx4 and the sensing circuits Rx1 to Rx4 are shown as intersecting each other in FIG. 2. It can be understood that in practice, the driving circuits Tx1 to Tx4 and the sensing circuits Rx1 to Rx4 can be set as being separated from each other by a certain distance. For example, as shown in FIG. 3, it is a schematic side view of the display panel 31 and the touch panel 21. A plurality of the driving circuits Tx are arranged on the lower surface of the touch panel 21, and a plurality of the sensing circuits Rx are arranged on the upper surface of the touch panel 21. It can be understood that the arrangements of the driving circuits Tx1˜Tx4 and the sensing circuits Rx1˜Rx4 may not be limited to those shown in FIGS. 2 and 3, and the driving circuits Tx1˜Tx4 and the sensing circuits Rx1˜Rx4 can also be set in other ways.

Referring to FIG. 1 again, the display panel 31 may comprise a plurality of pixels, and the pixels may be connected with the gate lines GL and the data lines DL. Each pixel may display an image in response to a signal from a corresponding one of the gate lines GL and a signal from a corresponding one of the data lines DL, wherein the display panel 31 may be one of an organic light emitting display panel, a liquid crystal display panel, a plasma display panel, an electrophoretic display panel, and an electrowetting display panel.

The display drive IC 32 may be electrically connected to the display panel 31 through the gate lines GL and the data lines DL, and may respond to a control signal (for example, vertical synchronization signal and horizontal synchronization signal) from an external device (for example, a timing controller), to control the voltages of the gate lines GL and the data lines DL.

When the display drive IC 32 provides a signal to the data line DL or the gate line GL connected with the display panel 31, or when the display panel 31 is operated, noise may be generated on the display panel 31. It can be understood that the noise may be generated by various electronic components of the display panel 31, or may be a noise signal transmitted by the various electronic components. Here, the noise signal may be an irregular voltage signal.

Since the touch panel 21 is disposed on the display panel 31, there will be one or more parasitic capacitors between the touch panel 21 and the display panel 31, and the noise signal generated on the display panel 31 is transmitted to the touch panel 21 through the one or more parasitic capacitors. The noise signal transmitted to the touch panel 21 will reduce the reliability of the touch sensing operation of the touch panel 21 and the touch drive IC 22, and for example, due to the noise signal coupled to the touch panel 21, the touch drive IC 22 cannot accurately detect the user's touch.

In this embodiment, since a noise signal may be couple to the touch panel 21, the touching signal received through the sensing circuit Rx may also be superimposed with the noise signal. Therefore, in the present application, the signal received by the sensing circuit Rx is called as the “sensing signal”.

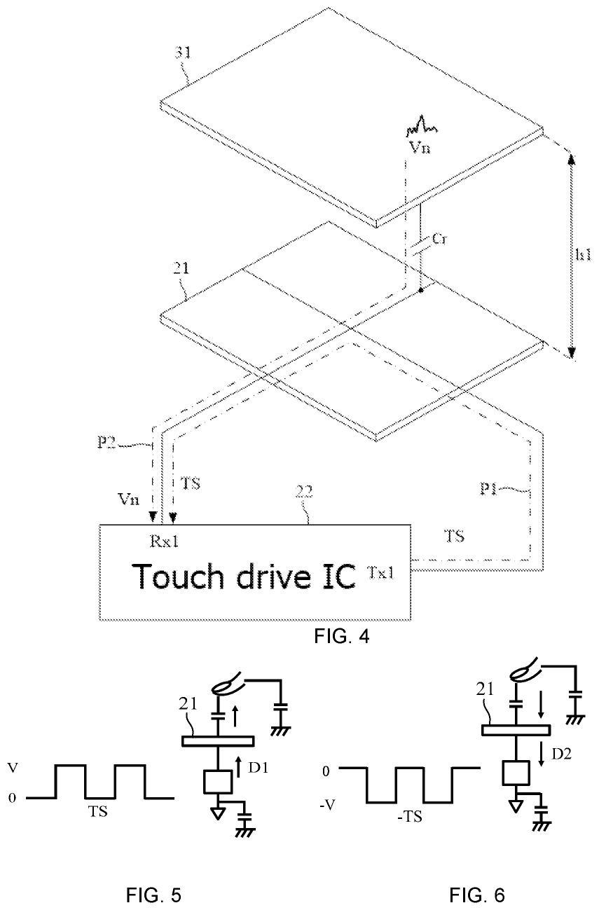

In order to better understand the inventive concept of the present application, the transmission of the noise signal on the display panel 31 will be briefly introduced below in conjunction with FIG. 4. It should be noted that, in order to simplify the description, components unnecessary for describing the noise signal are omitted in FIG. 4.

As shown in FIG. 4, the touch panel 21 and the display panel 31 may be arranged as being separated from each other by a first height h1. The driving signal TS which the touch drive IC 22 provides to the touch panel 21 through the first driving circuit Tx1 can be provided to the first sensing circuit Rx1 along the first path P1, and then return to the touch drive IC 22 through the first sensing circuit Rx1.

When a noise signal Vn is generated on the display panel 31, the noise signal Vn will be coupled to the touch panel 21 through the parasitic capacitor Cr between the touch panel 21 and the display panel 31, and is transmitted to the touch drive IC 22.

For example, the first sensing circuit Rx1 is separated from the display panel 31 by a first height h1 due to being disposed on the touch panel 21. Therefore, the parasitic capacitor Cr exists between the first sensing circuit Rx1 and the display panel 31, and becomes a transmission path of the noise signal Vn generated in the display panel 31, that is, the second path P2. In this way, the noise signal Vn generated in the display panel 31 can be transmitted to the touch drive IC 22 along the second path P2, so that the touching signal TS, which is received by the touch drive IC 22 through the first sensing circuit Rx1, is superimposed with the noise signal Vn, so that the touch drive IC 22 cannot perform an accurate touch sensing operation according to the received sensing signal, which therefore reduces the reliability of the touch sensing operation.

In order to enhance the reliability of the touch sensing operation, how to eliminate the noise signal in the sensing signals in the present application will be described in detail below.

In the first embodiment, the touch drive IC 22 is used to input two driving signals having equal amplitudes and opposite phases, to the same driving circuit Tx in one scanning period.

For example, in one scanning period, the touch drive IC 22 inputs two driving signals to the same driving circuit Tx, one of which is an AC signal TS and the other is an AC signal −TS.

In the first embodiment, the touch drive IC 22 is used to continuously input two driving signals having equal amplitudes and opposite phases, to the same drive circuit within one scanning period.

In the first embodiment, the touch drive IC 22 also receives a sensing signal through the sensing circuit Rx. Here, the sensing signals received by each of the sensing circuits Rx comprise a touching signal and an original noise signal, and two touching signals contained in the two sensing signals received through the same sensing circuit Rx have opposite phases.

As for a certain sensing circuit Rxn, in conjunction with FIGS. 2 and 4, it can be seen that the touching signal is transmitted to the sensing circuit Rxn through the driving circuit Txm that transmits the driving signal, and the mutual capacitor arranged between the driving circuit Txm and the sensing circuit Rxn, and finally transmitted to the touch drive IC 22. The original noise signal is directly transmitted from the touch panel 21 to the sensing circuit Rxn, and is transmitted to the touch drive IC 22 through the sensing circuit Rxn.

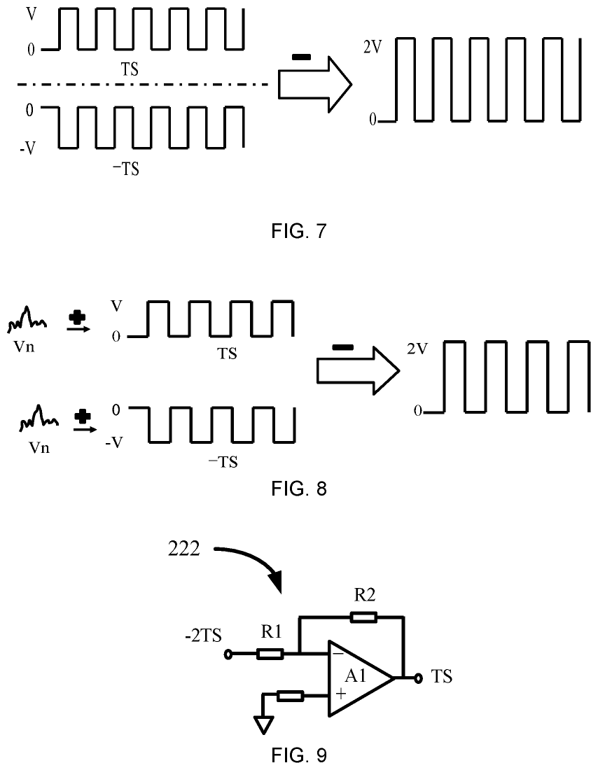

As shown in FIG. 5, if the touch drive IC 22 provides a driving signal TS to the touch panel 21, when a finger touches the touch panel 21, a current loop is formed between the touch panel 21 and the finger, and the current is transmitted in the first direction D1. As shown in FIG. 6, if the touch drive IC 22 provides again the driving signal −TS to the touch panel 21, when a finger touches the touch panel 21, current is transmitted in the second direction D2, wherein the second direction D2 and the first direction D1 are two opposite directions. It can be seen that since the phases of the two driving signals TS and −TS are opposite, the current signals flowing through the finger are also opposite. Therefore, as shown in FIG. 7, when the touch drive IC 22 respectively inputs two driving signals to the same driving circuit Tx wherein one of the driving signals is an AC signal TS and the other driving signal is an AC signal −TS, each sensing circuit Rx also receives two sensing signals, and the touching signals in the two received sensing signals are TS and −TS respectively, that is, the phases of the two touching signals are opposite.

The touch drive IC 22 is also used to perform a first signal processing on the two sensing signals received by each sensing circuit Rx and corresponding to the two driving signals transmitted on the same driving circuit, so as to remove or attenuate the original noise signal contained in the sensing signals received by the each sensing circuit Rx. Herein, in the first embodiment, the first signal processing is to perform subtraction on the two sensing signals received by each of the sensing circuits.

As shown in FIG. 7, since the two touching signals received by the same sensing circuit Rx have opposite phases, the subtraction on the two touching signals will not make them cancel each other, but obtain double touching signal.

As shown in FIG. 8, when the sensing signal comprises the noise signal Vn, as for the same sensing circuit Rx, the sensing signal sensed for the first time comprises the touching signal TS and the noise signal Vn and the sensing signal sensed for the second time comprises the touching signal −TS and the noise signal Vn. Since the phases of the sensed noise signals Vn of the two times have the same phases, the noise signals Vn in the two sensing signals will cancel each other when the two received sensing signals are subjected to the subtraction, and double touching signal will be obtained.

In an embodiment, the touch drive IC 22 may comprise a first signal processing module (not shown in the drawings), and the first signal processing module is configured to perform a first signal processing on the two sensing signals received by each of the sensing circuits Rx. Herein, the function of the first signal processing module can be implemented by a subtractor.

In the first embodiment, the touch drive IC 22 is also used to perform a second signal processing on the signal obtained after the first signal processing, so as to obtain a single touching signal received by each of the sensing circuits Rx. As described above, since the double touching signal is obtained after the first signal processing, in the first embodiment the second signal processing is to perform a multiple conversion on the signal obtained after the first signal processing.

In an embodiment, as shown in FIG. 9, the touch drive IC 22 may further comprise a second signal processing module 222, and the second signal processing module 222 is configured to perform a second signal processing on the signal obtained after the first signal processing, to obtain a single touching signal received by the sensing circuit.

Specifically, the function of the second signal processing module 222 may be implemented by a reverse adder A1. The reverse adder A1 receives, through its inverting input terminal, the signal obtained after the first signal processing, that is, the double touching signal −2TS, and outputs through its output terminal the single touching signal received by the sensing circuit Rx.

As shown in FIG. 9, the double touching signal −2TS is input to the inverting input terminal—of the reverse adder A1 through the resistor R1, and the inverting input terminal—of the reverse adder A1 is electrically connected to the output terminal of the reverse adder A1 via the resistor R2. The non-inverting input terminal+ of the reverse adder A1 is grounded through a resistor.

In FIG. 9, it can be seen from the concept of “virtual short circuit” that the voltages U− and U+ at the two input terminals of the reverse adder A1 are equal, namely:

U−=U+=0 (1)

According to the concept of “virtual open circuit” and Kirchhoff s law, the current passing through the resistor R1 is equal to the current passing through the resistor R2, so:

((−2TS)−U)/R1=(U−−Uo1)/R2 (2)

where, Uo1 is the voltage output by the output terminal of the reverse adder A1.

In the first embodiment, the relationship between the resistance values of the resistors R1 and R2 is: R1=2R2. Combining the above two formulas (1) and (2), it can be seen that the voltage Uo1 output by the output terminal of the reverse adder A1 is: Uo1=TS, that is, the signal output by the reverse adder A1 is equal to the single touching signal TS received by the sensing circuit Rx.

It is understandable that when the touch drive IC 22 senses the user's touch by means of controlling the plurality of sensing circuits Rx to receive the touching signals at the same time, the touch drive IC may comprise a plurality of the first signal processing modules and a plurality of the second signal processing modules 222 which are corresponding to the plurality of sensing circuits Rx one-to-one, and the plurality of first signal processing modules and the plurality of second signal processing modules 222 are respectively used for performing the first signal processing and the second signal processing on the sensing signals received by the corresponding sensing circuit Rx. When the touch drive IC 22 senses the user's touch by means of controlling the plurality of sensing circuits Rx to receive the touching signals sequentially, the touch drive IC may comprise one first signal processing module and one second signal processing module 222 which are respectively corresponding to the plurality of sensing circuits Rx, and the first signal processing module and the second signal processing module 222 are used for performing sequentially the first signal processing and the second signal processing on the sensing signals received by the plural sensing circuits Rx.

The touch device 100 provided in the first embodiment, based on the structure of the existing touch device 100, inputs respectively two driving signals having equal amplitudes and opposite phases to the same driving circuit within one scanning period, and performs a signal processing on the two sensing signals received by each sensing circuit and corresponding to the two driving signals transmitted on the same driving circuit, so as to effectively remove or attenuate the original noise signal contained in the sensing signals received by each sensing circuit, and obtains the single touching signal received by each sensing circuit, so that the touch drive IC 22 can perform accurate touch sensing operation according to the received sensing signals, and then improve the reliability of the touch sensing operation.

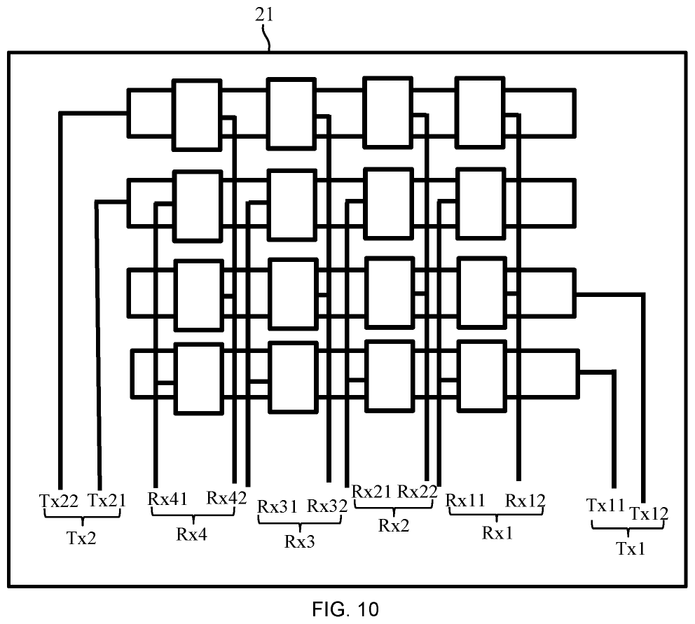

Referring to FIG. 10, it is a schematic diagram of the configuration structure of the driving circuits and the sensing circuits of the touch panel 21 provided by the second embodiment of the present application. As shown in FIG. 10, in the second embodiment, the touch panel 21 comprises plural groups of driving circuits Tx arranged in the row direction and plural groups of sensing circuits Rx arranged in the column direction. Here, each group of the driving circuits Tx comprises a first driving circuit and a second driving circuit, and each group of the sensing circuits Rx comprises a first sensing circuit corresponding to the first driving circuit of each group of driving circuits Tx and a second sensing circuit corresponding to the second driving circuit of each group of driving circuits R.

For convenience of description, FIG. 10 shows 2 groups of driving circuits Tx1 to Tx2 and 4 groups of sensing circuits Rx1 to Rx4, wherein the driving circuit Tx1 comprises a first driving circuit Tx11 and a second driving circuit Tx12, and the driving circuit Tx2 comprises a first driving circuit Tx21 and a second driving circuit Tx22. The sensing circuit Rx1 comprises a first sensing circuit Rx11 and a second sensing circuit Rx12, and the sensing circuit Rx2 comprises a first sensing circuit Rx21 and a second sensing circuit Rx22, and the sensing circuit Rx3 comprises a first sensing circuit Rx31 and the second sensing circuit Rx32, and the sensing circuit Rx4 comprise a first sensing circuit Rx41 and a second sensing circuit Rx42. It is understandable that in the second embodiment, the touch panel 21 is not limited to the structure shown in FIG. 10, and it further comprises more groups of driving circuits and more groups of sensing circuits.

In the second embodiment, the first driving circuits and the second driving circuits are alternately arranged, each in the row direction of the touch panel 21. In this way, each of the first driving circuits is arranged in an odd row/an even row and each of the second driving circuits is arranged in an even row/an odd row. The individual first sensing circuits, being in the column direction where it is located, correspond to the individual first driving circuits in the odd row/even row, and the individual second sensing circuits, being in the column direction where it is located, correspond to the individual second driving circuits in the even row/odd row.

In the second embodiment, the touch drive IC 22 is used to simultaneously input the driving signals having equal amplitudes and opposite phases, to the first driving circuit and the second driving circuit contained in the same group of the driving circuits Tx, in one scanning period.

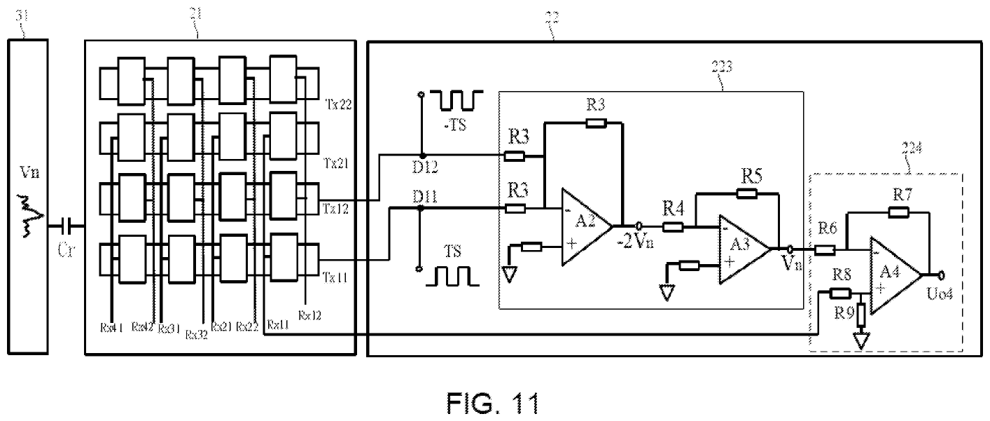

For example, as shown in FIG. 11, in one scanning period, the touch drive IC 22 inputs an AC signal TS to the first driving circuit Tx11 of the driving circuit Tx1, and simultaneously, inputs an AC signal −TS to the second driving circuit Tx12.

In the second embodiment, the touch drive IC 22 also receives a sensing signal through the sensing circuit Rx, and detects the transmission signal on the driving circuit that transmits the driving signal.

In the second embodiment, the sensing signals received by each sensing circuit comprise a touching signal and an original noise signal. Here, as for a certain sensing circuit Rxij, it corresponds to a certain driving circuit Txkj that transmits the driving signal. The touching signal is transmitted to the sensing circuit Rxij through the driving circuit Txkj and the mutual capacitor between the driving circuit Txkj and the sensing circuit Rxij, and finally transmitted to the touch drive IC 22. The original noise signal is directly transmitted from the touch panel 21 to the sensing circuit Rxij, and is transmitted to the touch drive IC 22 through the sensing circuit Rxij.

It is understandable that after the noise signal Vn is coupled to the touch panel 21, the noise signal Vn not only will be transmitted to the touch drive IC 22 through the wiring of the sensing circuit, but also will be transmitted to the touch drive IC 22 through the wiring of the driving circuit.

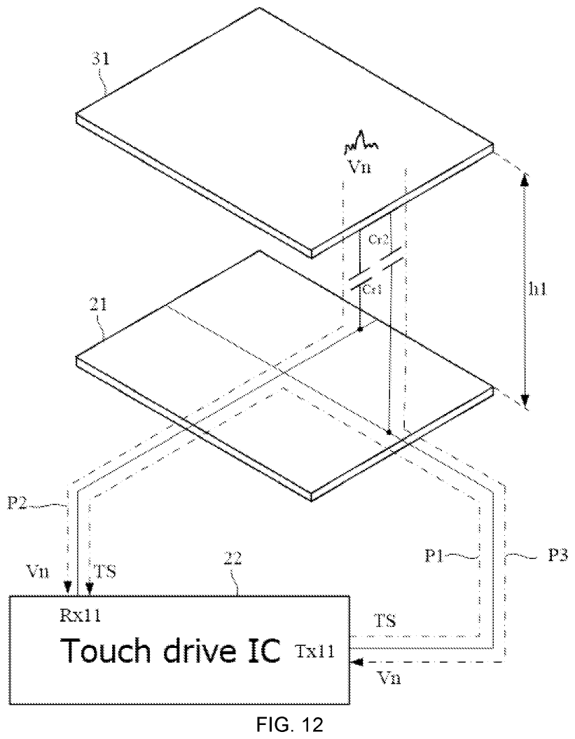

For example, as shown in FIG. 12, the first sensing circuit Rx11 and the first driving circuit Tx11 are separated, because of being disposed on the touch panel 21, from the display panel 31 by a first height h1. Therefore, the parasitic capacitor Cr1 exists between the first sensing circuit Rx11 and the display panel 31, and becomes a transmission path for the noise signal Vn generated in the display panel 31, that is, the second path P2. In the same way, the parasitic capacitor Cr2 will exist between the first driving circuit Tx11 and the display panel 31, and will become another transmission path for the noise signal Vn, that is, the third path P3. In this way, the noise signal Vn generated in the display panel 31 can be transmitted to the touch drive IC 22 along the second path P2, so that the tough signal TS which the touch drive IC 22 receives through the first sensing circuit Rx11 is superimposed with the noise signal Vn. At the same time, the noise signal Vn can also be transmitted to the touch drive IC 22 along the third path P3, so that it is possible to detect, through the driving circuit Tx11, the sum of the driving signal transmitted by the driving circuit Tx11 and the noise signal which the touch panel 21 transmits to the driving circuit Tx11.

In the second embodiment, the transmission signal is the sum of the driving signal transmitted by the corresponding driving circuit and the original noise signal that the touch panel transmits to the corresponding driving circuit. Specifically, in the second embodiment, the transmission signal comprises a first transmission signal and a second transmission signal, wherein the first transmission signal is sum of a driving signal transmitted by a corresponding first driving circuit and the noise signal which the control panel 21 transmits to the corresponding first driving circuit, and the second transmission signal is sum of a driving signal transmitted by a corresponding second driving circuit and the original noise signal which the control panel 21 transmits to the corresponding second driving circuit.

In the second embodiment, the touch drive IC 22 is also used to perform signal processing on detected transmission signal to obtain a single noise signal contained in the transmission signal.

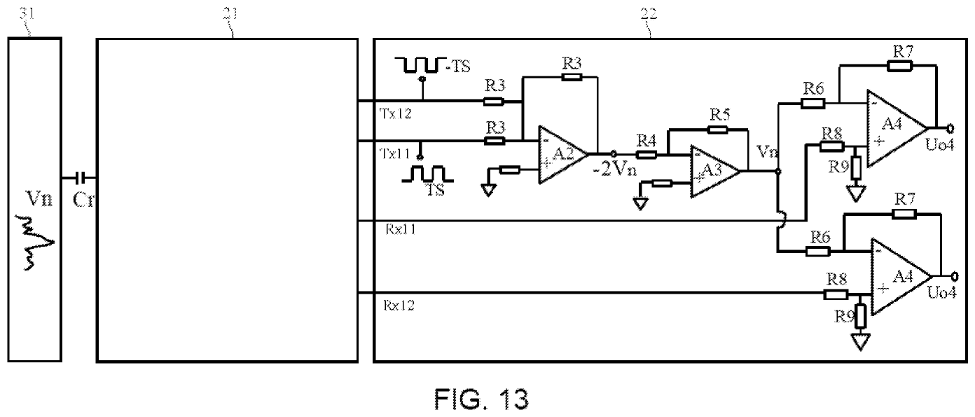

In an embodiment, as shown in FIG. 11 and FIG. 13, the touch drive IC 22 may further comprise a plurality of third signal processing modules 223 corresponding to a plurality of groups of the driving circuits Tx. The third signal processing module 223 is configured to perform the signal processing on the transmission signal detected on the corresponding driving circuit Tx, so as to obtain a single noise signal contained in the transmission signal.

Specifically, the third signal processing module 223 comprises a reverse adder A2, and the reverse adder A2 is used to perform addition operation on the transmission signal detected on the corresponding driving circuit, to obtain the sum of two noise signals contained in the transmission signal. Herein, the driving signals contained in the transmission signal cancel each other when the reverse adder A2 performs the addition operation.

For example, as shown in FIG. 11, the touch drive IC 22 inputs an AC signal TS to the first driving circuit Tx11 of the driving circuit Tx1, and simultaneously, inputs an AC signal −TS to the second driving circuit Tx12. The detection terminal D11 of the first driving circuit Tx11 is also electrically connected to the inverting input terminal—of the reverse adder A2 via the resistor R3, so that the reverse adder A2 receives, through the inverting input terminal thereof, the first transmission signal detected on the first driving circuit Tx11. The detection terminal D12 of the second driving circuit Tx12 is also electrically connected to the inverting input terminal—of the reverse adder A2 via the resistor R3, so that the reverse adder A2 receives, through the inverting input terminal thereof, the second transmission signal detected on the second driving circuit Tx12. The inverting input terminal—of the reverse adder A2 is also electrically connected via the resistor R3 to the output terminal of the reverse adder A2, and the non-inverting input terminal+ of the reverse adder A2 is grounded through a resistor.

Herein, the voltage of the detection terminal D11 is TS+Vn, and the voltage of the detection terminal D12 is −TS+Vn. Combining with the calculation principle for the voltage at the output terminal of the reverse adder A1 that has been described in detail above, it can be seen that the voltage at the output terminal of the reverse adder A2 is −2Vn.

In the one embodiment, the third signal processing module 223 further comprises a reverse adder A3, and the reverse adder A3 is configured to perform addition operation for the sum of the two noise signals, to obtain a single noise signal contained in the transmission signal.

For example, as shown in FIG. 11, the output terminal of the reverse adder A2 is electrically connected to the inverting input terminal—of the reverse adder A3 via a resistor R4, so that the reverse adder A3 receives, through the inverting input terminal thereof, the sum of the two noise signals output by the reverse adder A2. The inverting input terminal—of the reverse adder A3 is electrically connected to the output terminal of the reverse adder A3 through a resistor R5, and the non-inverting input terminal+ of the reverse adder A3 is grounded through a resistor.

Herein, the relationship between the resistance values of the resistors R4 and R5 is: R4=2R5. In combination with the calculation principle of the voltage at the output terminal of the reverse adder A1 described in detail above, it can be known that the signal output by the output terminal of the reverse adder A3 is Vn.

In the second embodiment, the touch drive IC 22 is also used to use the single noise signal to respectively cancel or attenuate the original noise signal contained in the sensing signals received by each sensing circuit.

In an embodiment, as shown in FIGS. 11 and 13, the touch drive IC 22 may further comprise a plurality of fourth signal processing modules 224 which are corresponding to a plurality of the sensing circuits one-to-one. The fourth signal processing module 224 is configured to use the single noise signal to cancel the original noise signal contained in the sensing signals received by the corresponding sensing circuit, to obtain the touching signal received by the corresponding sensing circuit.

Specifically, the function of the fourth signal processing module 224 can be implemented by a differential operator A4. The differential operator A4 is used to perform a differential operation on the sensing signal received by the corresponding sensing circuit and the single noise signal, to obtain the touching signal received by the corresponding sensing circuit.

For example, as shown in FIG. 11, the output terminal of the reverse adder A3 is electrically connected to the inverting input terminal—of the differential operator A4 through a resistor R6. That is, the single noise signal Vn output by the reverse adder A3 is input to the inverting input terminal—of the differential operator A4. The inverting input terminal—of the differential operator A4 is electrically connected to the output terminal of the differential operator A4 through a resistor R7. The first sensing circuit Rx11 is also electrically connected to the non-inverting input terminal+ of the differential operator A4 through a resistor R8, that is, the sensing signal TS+Vn received by the first sensing circuit Rx11 is input to the non-inverting input terminal+ of the differential operator A4, and the non-inverting input terminal+ of the differential operator A4 is also grounded through a resistor R9.

In FIG. 11, it can be seen from the concept of “virtual short circuit” that the voltages U− and U+ of the two input terminals of the differential operator A4 are equal to each other, that is:

U−=U+ (3)

According to the concept of “virtual open circuit” and the Kirchhoff s law, the current passing through the resistor R6 is equal to the current passing through the resistor R7, and the current passing through the resistor R8 is equal to the current passing through the resistor R9, so:

(Vn−U−)/R6=(U−−Uo4)/R7 (4)

((TS+Vn)−U+)/R8=U+/R9 (5)

where Uo4 is the voltage outputted by the output terminal of the differential operator A4.

In the second embodiment, the resistance values of the resistors R6, R7, R8, and R9 are equal to each other. Combining the above three formulas (3) to (5), it can be seen that the voltage Uo4 output by the output terminal of the differential operator A4 is: Uo4=TS, and the signal output by the differential operator A4 is equal to the touching signal TS received by the corresponding sensing circuit.

For convenience of description, only the third signal processing module 223 corresponding to one group of driving circuits Tx1 and the fourth signal processing module 224 corresponding to one of the sensing circuits Rx11 are shown in FIG. 11. FIG. 13 shows two fourth signal processing modules 224 corresponding to one group of sensing circuits Rx1.

The touch device 100 provided by the second embodiment, through improving the structure of the existing touch device 100, inputs simultaneously driving signals having equal amplitudes and opposite phases to two driving circuits included in the same group of driving circuits in one scanning period. While receiving the sensing signals through the sensing circuits, it detects the transmission signal on the driving circuit that transmits the driving signal, and processes the detected transmission signal to obtain a single noise signal contained in the transmission signal, and then uses the obtained single noise signal to respectively cancel or attenuate the original noise signal contained in the sensing signals received by each sensing circuit, to obtain the touching signals received by each sensing circuit, so that the touch drive IC 22 can perform accurate touch sensing operation according to the received sensing signals, and then improve the reliability of the touch sensing operation.

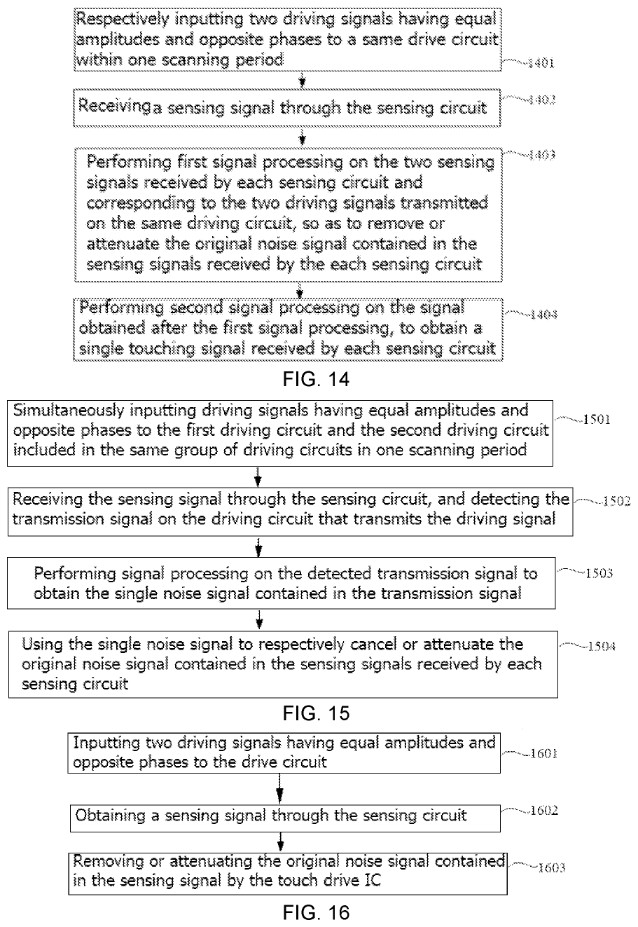

Referring to FIG. 14, it is a flowchart of a driving method for a touch device according to the first embodiment of the present application. The driving method is used to drive and control the above-mentioned touch device provided in the first embodiment. As shown in FIG. 14, the driving method comprises the following steps.

Step 1401, in which the touch drive IC 22 respectively inputs two driving signals having equal amplitudes and opposite phases, to the same drive circuit within one scanning period.

For example, in one scanning period, the touch drive IC 22 respectively inputs two driving signals to the same driving circuit Tx, one of which is an AC signal TS and the other of which is an AC signal −TS.

In the first embodiment, the touch drive IC 22 continuously inputs two driving signals having equal amplitudes and opposite phases, to the same driving circuit in one scanning period.

Step 1402, in which the touch drive IC 22 receives a sensing signal through the sensing circuit.

Herein, the sensing signals received by each of the sensing circuits Rx comprise a touching signal and an original noise signal, and the two touching signals contained in the two sensing signals received through the same sensing circuit Rx have opposite phases.

As for a certain sensing circuit Rxn, the touching signal is transmitted to the sensing circuit Rxn through a driving circuit Txm that transmits the driving signal, and a mutual capacitor arranged between the driving circuit Txm and the sensing circuit Rxn, and finally transmitted to the touch drive IC 22. The original noise signal is directly transmitted from the touch panel to the sensing circuit Rxn, and is transmitted to the touch drive IC 22 through the sensing circuit Rxn.

Step 1403, in which the touch drive IC 22 performs the first signal processing on the two sensing signals received by each sensing circuit and corresponding to the two driving signals transmitted on the same driving circuit, so as to remove or attenuate the original noise signal contained in the sensing signals received by the each sensing circuit.

Herein, in the first embodiment, the first signal processing is to perform subtraction on the two sensing signals received by each of the sensing circuits. It is understandable that, as shown in FIG. 8, since the two touching signals contained in the two sensing signals received by the same sensing circuit Rx have opposite phases and the two noise signals have the same phases, the two noise signals in the two sensing signals will cancel each other when the two sensing signals are subjected to the subtraction, and double touching signal will be obtained.

Step 1404, in which the touch drive IC performs the second signal processing on the signal obtained after the first signal processing, to obtain a single touching signal received by each of the sensing circuits.

As described above, since the double touching signal is obtained after the first signal processing, in the first embodiment, the second signal processing is to perform the multiple conversion on the signal obtained after the first signal processing.

Specifically, in the first embodiment, the second signal processing is to use a reverse adder to perform the addition operation on the signal obtained after the first signal processing, to obtain the single touching signal received by the sensing circuit.

The driving method provided by the first embodiment, based on the structure of the existing touch device, inputs respectively two driving signals having equal amplitudes and opposite phases to the same driving circuit in one scanning period and performs signal processing on the two transmission signals received by each sensing circuit and corresponding to two driving signals transmitted on the same driving circuit, to effectively remove or attenuate the original noise signal contained in the sensing signals received by each sensing circuit and obtain the single touching signal received by each sensing circuit, so that the touch drive IC 22 can perform the accurate touch sensing operation according to the received sensing signals, thereby improving the reliability of the touch sensing operation.

Referring to FIG. 15, it is a flowchart of a driving method for a touch device according to a second embodiment of the present application. The driving method is used to drive and control the touch device provided in the second embodiment. As shown in FIG. 15, the driving method comprises the following steps.

Step 1501, in which the touch drive IC 22 simultaneously inputs driving signals having equal amplitudes and opposite phases to the first driving circuit and the second driving circuit included in the same group of driving circuits in one scanning period.

Step 1502, in which the touch drive IC 22 receives the sensing signal through the sensing circuit, and detects the transmission signal on the driving circuit that transmits the driving signal.

In the second embodiment, the sensing signals received by each sensing circuit comprise a touching signal and an original noise signal, wherein as for a certain sensing circuit Rxij, it corresponds to a certain driving circuit Txkj that transmits the driving signal. The touching signal is transmitted to the sensing circuit Rxij through the driving circuit Txkj and the mutual capacitor arranged between the driving circuit Txkj and the sensing circuit Rxij, and finally transmitted to the touch drive IC 22. The original noise signal is directly transmitted from the touch panel 21 to the sensing circuit Rxij, and is transmitted to the touch drive IC 22 through the sensing circuit Rxij.

In the second embodiment, the transmission signal is the sum of the driving signal transmitted by the corresponding driving circuit and the original noise signal that the touch panel transmits to the corresponding driving circuit. Specifically, in the second embodiment, the transmission signal comprises a first transmission signal and a second transmission signal, wherein the first transmission signal is sum of a driving signal transmitted by a corresponding first driving circuit and the noise signal which the control panel 21 transmits to the corresponding first driving circuit, and the second transmission signal is sum of a driving signal transmitted by a corresponding second driving circuit and the original noise signal which the control panel 21 transmits to the corresponding second driving circuit.

Step 1503, in which the touch drive IC 22 performs a signal processing on the detected transmission signal to obtain the single noise signal contained in the transmission signal.

In an embodiment, the step 1503 comprises:

using the first reverse adder to perform the addition operation on the detected transmission signal, to obtain the sum of the two noise signals contained in the transmission signal; and

using the second reverse adder to perform the addition operation on the sum of the two noise signals, to obtain a single noise signal contained in the transmission signal.

Step 1504, in which the touch drive IC 22 uses the single noise signal to respectively cancel or attenuate the original noise signal contained in the sensing signals received by each sensing circuit.

In an embodiment, the step 1504 specifically comprises:

using the differential operator to perform the differential operation on the sensing signals received by each sensing circuit and the single noise signal respectively, to obtain the touching signal received by each sensing circuit.

The driving method provided by the second embodiment, based on the structure of the improved touch device, inputs simultaneously driving signals having equal amplitudes and opposite phases to two driving circuits included in the same group of driving circuits in one scanning period. While receiving the sensing signals through the sensing circuits, it detects the transmission signal on the driving circuit that transmits the driving signal, and processes the detected transmission signal to obtain a single noise signal contained in the transmission signal, and then uses the obtained single noise signal to respectively cancel or attenuate the original noise signal contained in the sensing signals received by each sensing circuit, to obtain the touching signals received by each sensing circuit, so that the touch drive IC 22 can perform the accurate touch sensing operation according to the received sensing signals, and then improve the reliability of the touch sensing operation.

Referring to FIG. 16, it is a flowchart of a driving method for a touch device according to the third embodiment of the present application. As shown in FIG. 16, the driving method comprises the following steps.

Step 1601, in which two driving signals having equal amplitudes and opposite phases are input to the drive circuit.

Step 1602, in which a sensing signal is obtained through the sensing circuit.

Step 1603, in which the original noise signal contained in the sensing signal is removed or weakened by the touch drive IC.

In one embodiment, the driving method shown in FIG. 16 can be used to drive and control the above-mentioned touch device provided in the first embodiment. It can be understood that the driving method can also be used to drive and control other touch devices.

Specifically, Step 1601 may comprise: respectively inputting two driving signals having equal amplitudes and opposite phases, to the same driving circuit within one scanning period.

Further, the two driving signals are continuously input into the same driving circuit.

Step 1602 may comprise: respectively obtaining two sensing signals corresponding to two driving signals transmitted on the same driving circuit, through a sensing circuit, wherein each of the sensing signals comprises a touching signal and the original noise signal, and the two touching signals contained in two sensing signals obtained through the same sensing circuit have opposite phases.

Step 1603 may comprise: performing the subtraction, through the touch drive IC, on the two sensing signals obtained by the same sensing circuit, to remove or attenuate the original noise signal.

Further, after Step 1603, the method may further comprise: restoring the two sensing signals after subtraction, to a single touching signal, so as to obtain a single touching signal received by each sensing circuit.

In the driving method provided in the one embodiment, two driving signals having equal amplitudes and opposite phases are input respectively to the same driving circuit within one scanning period, and the subtraction is performed on the two sensing signals received by each sensing circuit and corresponding to the two driving signals transmitted on the same driving circuit, so as to effectively remove or attenuate the original noise signal contained in the sensing signals received by each sensing circuit, and obtains the single touching signal received by each sensing circuit, so as to enable the touch drive IC 22 to perform accurate touch sensing operation according to the received sensing signals, and further improve the reliability of the touch sensing operation.

In another embodiment, the driving method shown in FIG. 16 is used to drive and control the touch device provided in the second embodiment. It can be understood that the driving method can also be used to drive and control other touch devices.

Specifically, Step 1601 may comprise: simultaneously inputting two driving signals having equal amplitudes and opposite phases to two adjacent driving circuits in one scanning period.

After the step 1601, the method may further comprise: obtaining a noise signal through a driving circuit that transmits the driving signal.

Further, the obtaining a noise signal through a driving circuit that transmits the driving signal may comprise:

respectively obtaining the original noise signal transmitted by the touch panel and the corresponding driving signal, from the two driving circuits that transmit the driving signal;

processing, by the touch drive IC, the signals obtained from the two driving circuits, to remove the driving signal contained in the obtained signals and output a double noise signal (i.e. two-fold noise signal); and

restoring the output double noise signal to a single-fold noise signal through the touch drive IC.

Herein, the sensing signal comprises a touching signal and the original noise signal.

Further, Step 1603 may comprise: using the touch drive IC, to make the single-fold noise signal and the original noise signal in the sensing signal cancel each other, to obtain the touching signal contained in the sensing signal obtained by each sensing circuit.

In the driving method provided in the another embodiment, in one scanning period, driving signals having equal amplitudes and opposite phases are simultaneously input to two adjacent driving circuits. While receiving the sensing signal through the sensing circuit, the noise signal is obtained through the driving circuit that transmits the driving signal, and then the obtained noise signal is used to cancel or attenuate the original noise signal contained in the sensing signal received by each sensing circuit, to obtain the touching signal received by each sensing circuit, so that the touch drive IC 22 can perform the accurate touch sensing operation according to the received sensing signals, thereby improving reliability of the touch sensing operation.

Finally, it should be noted that the above embodiments are only used to illustrate the technical solutions of the present application and not to limit it. Although the present application has been described in detail with reference to the above preferred embodiments, those skilled in the art should understand that modifications or equivalent substitutions of the technical solutions of the present application should not depart from the spirit and scope of the technical solution of the present application.

1. A driving method for a touch device, wherein the touch device comprises a touch panel, and a plurality of driving circuits and a plurality of sensing circuits are provided on the touch panel, with the driving method comprising:
inputting respectively two driving signals, which have equal amplitudes and opposite phases, to a same driving circuit in one scanning period;
receiving a sensing signal through the sensing circuits; and
performing a first signal processing on two sensing signals received by each sensing circuit and corresponding to the two driving signals transmitted on the same driving circuit, so as to remove or attenuate an original noise signal contained in the sensing signals received by each sensing circuit.

2. The driving method according to claim 1, wherein the inputting respectively two driving signals which have equal amplitudes and opposite phases to a same driving circuit in one scanning period comprises: inputting continuously two driving signals which have equal amplitudes and opposite phases to the same driving circuit in one scanning period.

3. The driving method according to claim 1, wherein each of the sensing signals received by the each sensing circuit comprises a touching signal and the original noise signal, and two touching signals contained in the two sensing signals received by a same sensing circuit have opposite phases.

4. The driving method according to claim 3, wherein the first signal processing is to perform subtraction on the two sensing signals received by the each sensing circuits.

5. The driving method according to claim 4, wherein the driving method further comprises:
performing a second signal processing on a signal obtained after the first signal processing, to obtain a single touching signal received by each of the sensing circuits.

6. The driving method according to claim 5, wherein the second signal processing is to use a reverse adder to perform an addition operation on signals obtained after the first signal processing, so as to obtain the single touching signal received by each of the sensing circuits.

7. A touch device, comprising a touch panel and a touch drive IC, the touch panel being provided with plural driving circuits and plural sensing circuits, wherein the touch drive IC is configured for:
inputting respectively two driving signals, which have equal amplitudes and opposite phases, to a same driving circuit in one scanning period;
receiving a sensing signal through the sensing circuits; and
performing a first signal processing on two sensing signals received by each sensing circuit and corresponding to the two driving signals transmitted on the same driving circuit, so as to remove or attenuate a noise signal contained in the sensing signals received by each sensing circuit.

8. The touch device according to claim 7, wherein the touch drive IC is configured to continuously input the two driving signals having equal amplitudes and opposite phases, to the same drive circuit within one scanning period.

9. The touch device according to claim 7, wherein each of the sensing signals received by the each sensing circuit comprises a touching signal and the noise signal, and two touching signals contained in the two sensing signals received by the same sensing circuit have opposite phases.

10. The touch device according to claim 9, wherein the first signal processing is to perform subtraction on the two sensing signals received by the each sensing circuit.

11. The touch device according to claim 10, wherein the touch drive IC is further configured for performing a second signal processing on a signal obtained after the first signal processing, to obtain a single touching signal received by each of the sensing circuits.

12. The touch device according to claim 11, wherein the touch drive IC comprises a reverse adder, and the reverse adder is configured to perform an addition operation on the signal obtained after the first signal processing, to obtain a single touching signal by the sensing circuit.

13. A driving method for a touch device, the touch device comprising a touch panel, the touch panel comprising a plurality of groups of driving circuits arranged in a row direction and a plurality of groups of sensing circuits arranged in a column direction, wherein each group of the driving circuits comprises a first driving circuit and a second driving circuit, and each group of the sensing circuits comprises a first sensing circuit corresponding to the first driving circuit of the each group of driving circuits and a second sensing circuit corresponding to the second driving circuit of the each group of driving circuits, the driving method comprising:
inputting simultaneously driving signals, which have equal amplitudes and opposite phases, to the first driving circuit and the second driving circuit comprised in a same group of driving circuits in one scanning period;
receiving a sensing signal through the sensing circuits, and detecting a transmission signal on the driving circuit that transmits the driving signal, wherein the transmission signal is a sum of the driving signal transmitted by the corresponding driving circuit and an original noise signal that the touch panel transmits to the corresponding driving circuit;
performing a signal processing on the detected transmission signal to obtain a single noise signal contained in the transmission signal; and
using the single noise signal to respectively cancel or attenuate the original noise signal contained in the sensing signals received by each sensing circuit.

14. The driving method according to claim 13, wherein the sensing signal received by the each sensing circuit comprises a touching signal and the original noise signal.

15. The driving method according to claim 13, wherein the transmission signal comprises:
a first transmission signal, which is a sum of the driving signal transmitted by the corresponding first driving circuit and a noise signal which the touch panel transmits to the corresponding first driving circuit; and
a second transmission signal, which is a sum of the driving signal transmitted by the corresponding second driving circuit and a noise signal which the touch panel transmits to the corresponding second driving circuit.

16. The driving method according to claim 15, wherein the performing a signal processing on the detected transmission signal to obtain a single noise signal contained in the transmission signal comprises:
using a first reverse adder to perform an addition operation on the detected transmission signal to obtain a sum of two noise signals contained in the transmission signal; and
using a second reverse adder to perform an addition operation on the two noise signals to obtain the single noise signal contained in the transmission signal.

17. The driving method according to claim 16, wherein the using the single noise signal to respectively cancel or attenuate the original noise signal contained in the sensing signals received by each sensing circuit comprises:
using a differential operator to perform a differential operation on the sensing signals received by each sensing circuit and the single noise signal, to obtain the touching signal received by each sensing circuit.

18. The driving method according to claim 13, wherein the first driving circuits and the second driving circuits are alternately arranged, each in a row direction of the touch panel.

19-34. (canceled)

35. The driving method according to claim 2, wherein each of the sensing signals received by the each sensing circuit comprises a touching signal and the original noise signal, and two touching signals contained in the two sensing signals received by a same sensing circuit have opposite phases.

36. The touch device according to claim 8, wherein each of the sensing signals received by the each sensing circuit comprises a touching signal and the noise signal, and two touching signals contained in the two sensing signals received by the same sensing circuit have opposite phases.
